(19) United States
(12) Patent Application Publication
(10) Pub. No.: US 2024/0256915 A1
(43) Pub. Date: Aug. 1, 2024

(54) TIME SERIES FORECASTING USING MULTIVARIATE TIME SERIES DATA WITH MISSING VALUES

(71) Applicant: International Business Machines Corporation, Armonk, NY (US)

(72) Inventors: Lam Minh NGUYEN, Ossining, NY (US); Huyen Trang Tran, Ithaca, NY (US); Kyong Min Yeo, Scarsdale, NY (US); Nam H. NGUYEN, Pleasantville, NY (US); Dzung Tien PHAN, Pleasantville, NY (US); Roman VACULIN, Larchmont, NY (US); Jayant R. KALAGNANAM, Briarcliff Manor, NY (US)

(21) Appl. No.: 18/161,061

(22) Filed: Jan. 28, 2023

(51) Int. Cl. G06N 5/022

(52) U.S. Cl. CPC G06N 5/022

(57) ABSTRACT

A prediction system may identify a first set of features of training data and a second set of features of the training data. The prediction system may train a deep learning model using the training data. Training the deep learning model may comprise training a first function to determine a relationship between the first set of features and the second set of features. Training the deep learning model may further comprise training a second function to determine a relationship between missing data of a first period of time and complete data of a second period of time that follows the first period of time. The prediction system may generate imputation time series data and forecasted time series data using the trained deep learning model. The imputation time series data is generated based on an imputation task and the forecasted time series data is generated based on a forecasting task.

### BACKGROUND

The present invention relates to time series forecasting, and more specifically, to time series forecasting using multivariate time series data with missing values. A time series refers to a series of data points that are provided in a chronological order. Time series forecasting refers to forecasting or predicting additional (future) data points based on the series of data points.

### SUMMARY

In some implementations, a computer-implemented method comprises: identifying a first set of features of training data and a second set of features of the training data; and training a deep learning model using the training data. Training the deep learning model comprises training a first function to determine a relationship between the first set of features and the second set of features, and training a second function to determine a relationship between missing data of a first period of time and complete data of a second period of time that follows the first period of time. The computer-implemented method further comprises generating imputation time series data and forecasted time series data using the trained deep learning model.

The imputation time series data is generated based on the trained deep learning model performing an imputation task on input data, and the forecasted time series data is generated based on the trained deep learning model performing a forecasting task on the input data.

In some implementations, a computer program product comprises one or more computer readable storage media, and program instructions collectively stored on the one or more computer readable storage media, the program instructions comprising: program instructions to train a machine learning model using training data. The training data includes a first set of features and a second set of features. The program instructions to train the machine learning model comprise: program instructions to train a first function to determine a relationship between the first set of features and the second set of features, and program instructions to train a second function to determine a relationship between missing data of a first period of time and complete data of a second period of time that follows the first period of time. The program instructions further comprise program instructions to generate imputation time series data and forecasted time series data using the trained machine learning model. The imputation time series data is generated based on the trained machine learning model performing an imputation task on the input data, and the forecasted time series data is generated based on the trained machine learning model performing a forecasting task on the input data; and program instructions to control an operation of one or more devices using the imputation time series data and the forecasted time series data.

In some implementations, a system comprises one or more devices configured to: train a machine learning model using training data. The one or more devices are configured to: train a first function to determine a relationship between the first features and the second features, and train a second function to determine a relationship between missing data of a first period of time and complete data of a second period of time that follows the first period of time. The training data includes first features and second features. The one or more devices are configured to generate imputation time series data and forecasted time series data using the trained machine learning model. The imputation time series data is generated based on the trained machine learning model performing an imputation task on the input data, and the forecasted time series data is generated based on the trained machine learning model performing a forecasting task on the input data. The one or more devices are configured to provide the imputation time series data and the forecasted time series data to control an operation of a system.

### BRIEF DESCRIPTION OF THE DRAWINGS

FIGS. 1A-1D are diagrams of an example implementation described herein.

FIG. 2 is a diagram of an example environment in which systems and/or methods described herein may be implemented.

FIG. 3 is a diagram of an example computing environment in which systems and/or methods described herein may be implemented.

FIG. 4 is a diagram of example components of one or more devices of FIGS. 2 and 3.

FIG. 5 is a flowchart of an example process relating to time series forecasting using multivariate time series data with missing values.

### DETAILED DESCRIPTION

The following detailed description of example implementations refers to the accompanying drawings. The same reference numbers in different drawings may identify the same or similar elements.

Typically, a time series is a univariate time series. In other words, the univariate time series is a series of a single time-dependent variable. For example, the single time-dependent variable may be a temperature and the univariate time series may be a series of temperatures over a period of time. The univariate time series may include univariate time series data (e.g., different values of the single time-dependent variable at different times).

In contrast to the univariate time series, a multivariate time series is a series of multiple time-dependent variables. For example, the multiple time-dependent variables may include a temperature, a measure of pressure, and/or a measure of humidity, among other examples of weather related variable. The multivariate time series may be a series of temperatures, measures of pressure, and/or measures of humidity over a period of time. The multivariate time series may include multivariate time series data refers to (e.g., different values of the multiple time-dependent variable at different times).

Multivariate time series and/or multivariate time series data appear in various applications. For example, multivariate time series and/or multivariate time series data are utilized in economics, transportation, and/or manufacturing, among other examples. For instance, making a multiple-step ahead prediction of a state of a system (of one or more devices or machines) given a set of sensor observations is one of the major interests in many industrial applications. The industrial applications include chemical reactors, wind farms, power grids, blast furnace, among other examples.

Multivariate time series forecasting refers to prediction of values (e.g., future values) for multiple time-dependent variables. In the context of multivariate time series data of a system (of one or more devices or machines), the values of the multiple time-dependent variables may be predicted with the goal to learn a temporal evolution of system data (of the system) and to make decisions to improve an operation of the system.

Typically, the multivariate time series data (of the system) is subject to a significant number of missing values. The values may be missing due to malfunction of devices (e.g., sensor devices) used for data collection, malfunction of devices (e.g., storage devices) used to store the multivariate time series data, corruption of the multivariate time series data during and/or after the storage process (e.g., corruption of a data structure), corruption of the multivariate time series data during transmission from the storage devices, and/or a multi-resolution sensor network, among other examples.

Additionally or alternatively, the values may be missing because the multivariate time series data is infrequently collected, the process for collecting and/or processing the multivariate time series data is expensive and time consuming, among other examples. In this regard, the missing values pose a challenge with respect to learning the temporal evolution and/or a temporal dynamic on the missing values.

Additionally, the missing values pose a challenge with respect to inferring knowledge from the missing values. For example, performing multivariate time series forecasting using multivariate time series data with missing values is a complex computational task. Accordingly, performing multivariate time series forecasting using multivariate time series data with missing values is time consuming task. Furthermore, performing multivariate time series forecasting using multivariate time series data with missing values may lead to inaccuracies with respect to forecasted multivariate time series data. Such inaccurate forecasted multivariate time series data may negatively affect the operation of the system that relies on the forecasted multivariate time series data.

A common approach to addressing the multivariate time series data with the missing values is to use an imputation model to predict the missing values based on the multivariate time series data and use an inference model to predict the multivariate time series data using an output of the imputation model. One weakness of the common approach is that a model performs a single task at one time (not simultaneously): either an imputation task or a prediction task. Another weakness of the common approach is that the inference model does not have access to the multivariate time series data provided to the imputation model. As a result, the multivariate time series data predicted by the inference model may be inaccurate. One weakness of the common approach is that the output from the imputation is fixed and not learnable. For example, because the imputation step and the forecasting (or inference) step are separated, the product of the imputation step is fixed and the forecasting signal cannot be used to change the imputation step (e.g., to learn the imputation output). Similarly, the inference model does not have access to the (original) multivariate time series data, but it can only work with the imputation output (which is fixed).

Implementations described herein provide solutions to overcome the above issues relating to forecasting multivariate time series based on multivariate time series data with missing data. For example, implementations described herein are directed to a multi-task time series model that simultaneously imputes (or determines) missing values of multivariate time series data and makes a multiple-step ahead prediction (e.g., predicts future multivariate time series data). In some examples, the multi-task model may be a machine learning model.

In some implementations, the multi-task time series model may provide a framework for time series for processing of time series data with two sets of features. The first set of features may be easier to observe than the second set of features. In some embodiments or circumstances, the first set of features may be quantitative features that can be measured (e.g., using sensor devices). For example, the first set of features may include data that can be quantified and analyzed (e.g., analyzed statistically). For instance, the first set of features may be numerical values. The second set of features may be qualitative features. For example, the second set of features may include data that may not be objectively quantified or measured. For instance, the second set of features may indicate a level of quality of an item (or product), a level of performance of the item (or product), among other examples.

As an example, with respect to multivariate time series data relating to manufacturing, the first set of features may indicate various elements (or components) of a product. The elements (or components) may be determined based on sensor data from one or more sensor devices. The second set of features may indicate a level of quality of the product. The level of quality may depend on the first set of features.

In some embodiments or circumstances, the first set of features may be a set of input features and the second set of features may be a set of target features. The multi-task model may be configured to determine a relationship between the first set of features and the second set of features. In some situations, the first set of features may be partially observed while the second set of features may be partially missing or completely missing.

The multi-task model may be configured to perform an imputation task and a forecasting task using a same multivariate time series data. As used herein, an “imputation task” is an action performed by the multi-task model to predict values for missing data from a data set (e.g., time series data). For example, when performing an imputation task, the multi-task model may replace the missing data with the predicted values. As used herein, a “forecasting task” is an action performed by the multi-task model to predict additional values for a data set. For example, when performing a forecasting task, the multi-task model may predict future data (or future values) for the time series data. The multivariate time series data may be provided with missing values. In this regard, the multi-task model may perform the imputation task on the multivariate time series data to determine (or predict) the missing values (e.g., for a current period of time). Simultaneously, the multi-task model may perform the forecasting task on the multivariate time series data to predict future values for the multivariate time series data (e.g., for a next period of time).

Based on the foregoing, the multi-task model may include two functions (or learner functions). The first function may be configured to determine the relationship between the first set of features and the second set of features. The second function may be configured to simultaneously perform imputation tasks and forecasting tasks on a same multivariate time series data. The second function may be configured to simultaneously perform the imputation tasks and the forecasting tasks by determining a relationship between missing data of a first period of time and complete data of a second period of time that follows the first period of time. The first function may a spatial relation function while the second function may be a temporal relation function. In this regard, the first function and the second function may be invariant in time and space dimension, respectively.

The functions may be trained using a training loss function configured to simultaneously learn a regression task (to determine the relationship between the sets of features), an imputation task (for a current period of time), and a forecasting task (for a future period of time). For at least the foregoing reasons, implementations described herein handle the processing of full data (e.g., multivariate time series data with no missing values) and missing data (e.g., multivariate time series data with missing values) with flexibility. Additionally, implementations described herein handle various time series tasks (e.g., imputation tasks and forecasting tasks).

In contrast to the common approach described above, implementations described herein infer knowledge directly from time series data with missing value. Additionally, implementations described herein solve imputation and forecasting task simultaneously. Furthermore, implementations described herein provides a representation of full data is that flexible and learnable.

For at least the foregoing reasons, implementations described herein may preserve computing resources, network resources, and other resources that would have otherwise been used by the common approach to addressing missing values in multivariate time series data, used to remedy inaccuracies with respect to forecasted multivariate time series data under the common approach, among other examples.

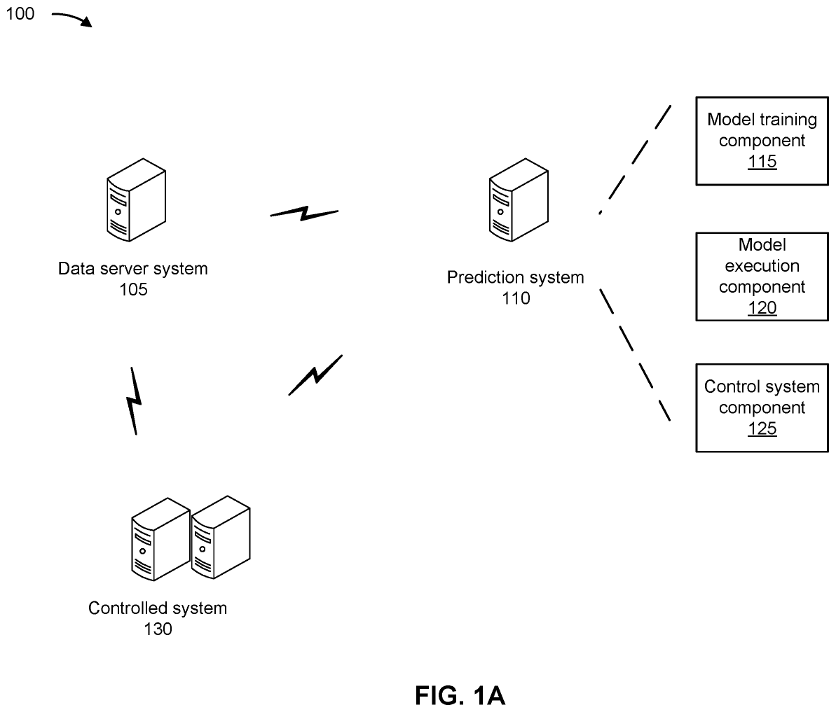

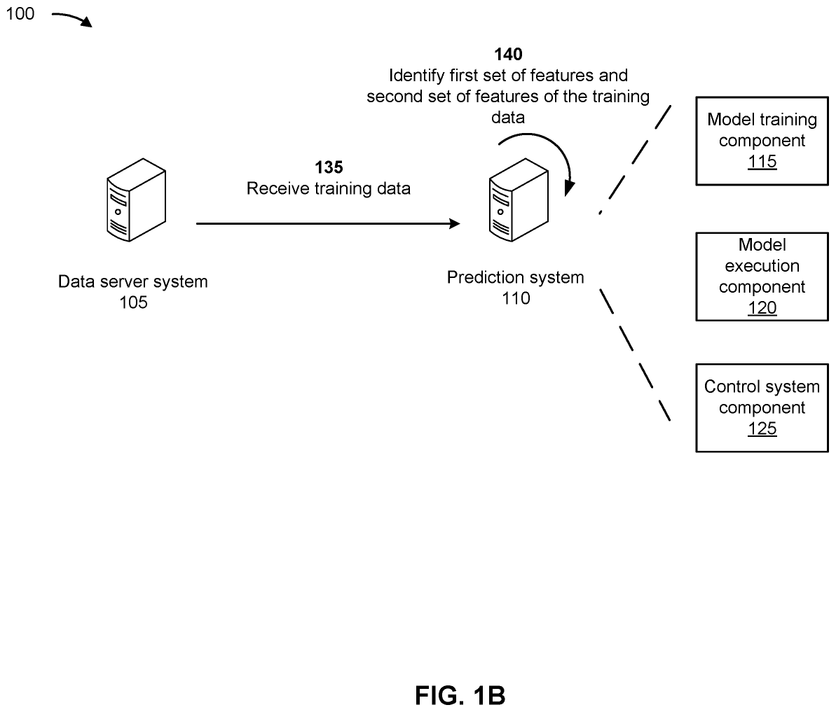

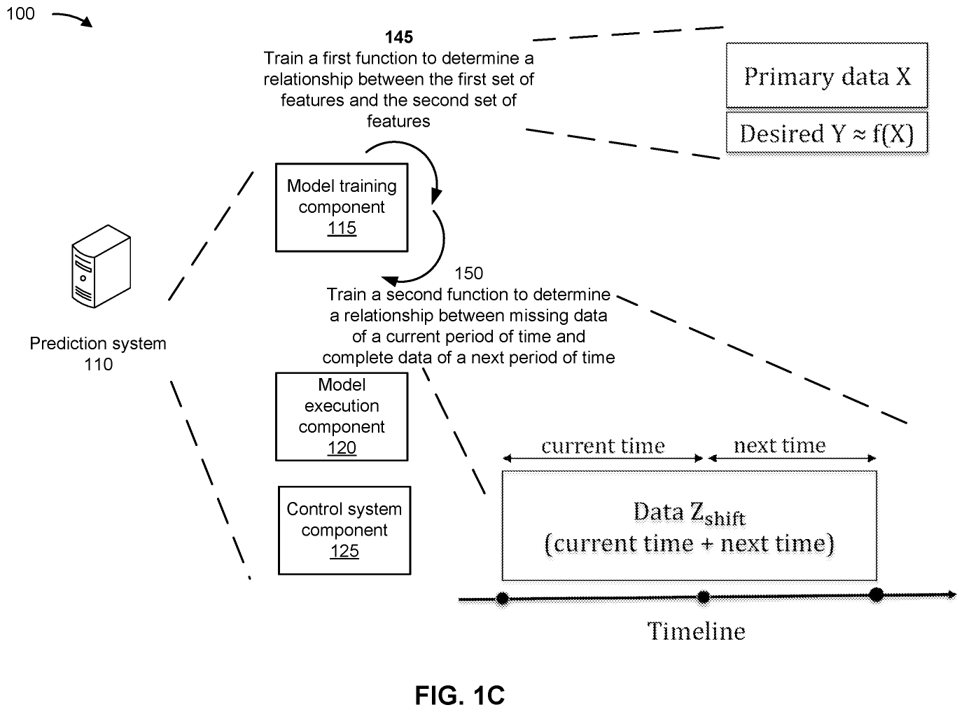

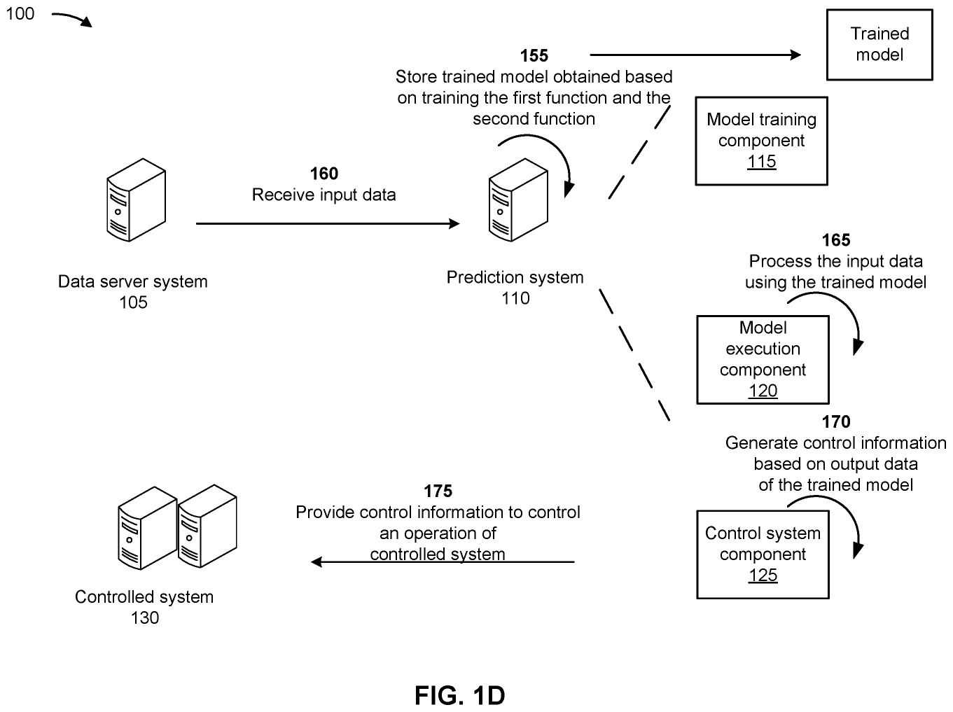

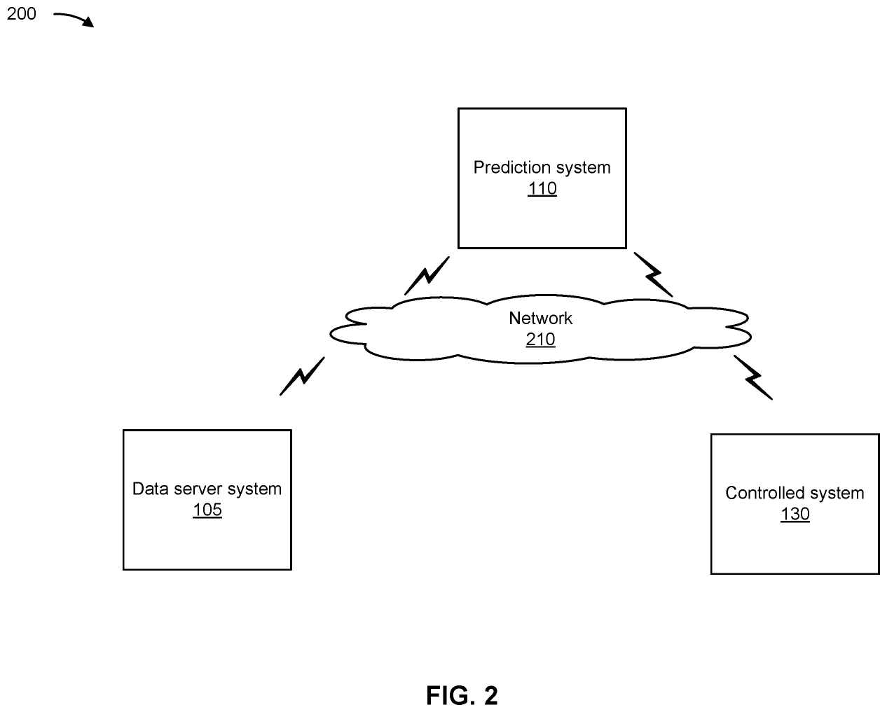

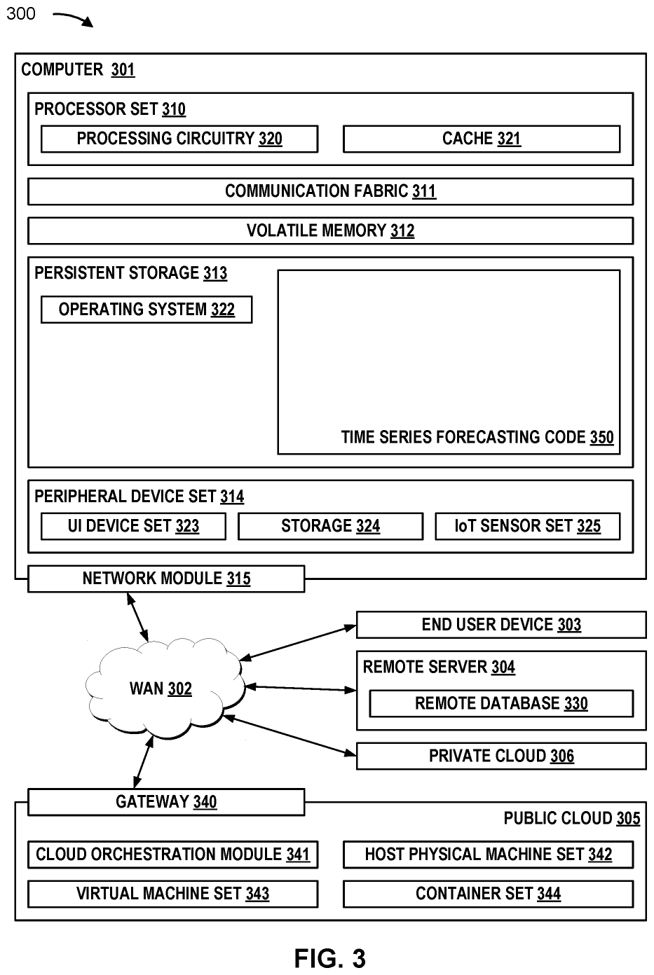

FIGS. 1A-1D are diagrams of an example implementation 100 described herein. As shown in FIGS. 1A-1D, example implementation 100 includes a data server system 105, a prediction system 110, and a controlled system 130. These devices are described in more detail below in connection with FIG. 2 and FIG. 3.

Data server system 105 may include one or more devices configured to receive, generate, store, process, and/or provide information associated with time series forecasting using multivariate time series data with missing values, as explained herein. In some examples, data server system 105 may store multivariate time series data that includes a first set of features and a second set of features. In some examples, the multivariate time series data may be used as training data to train models.

The first set of features may be quantitative features that can be measured. For example, the first set of features may be obtained using sensor devices. The second set of features may be qualitative features.

In the context of a manufacturing system, the multivariate time series data may relate to a manufacturing process and the first set of features may indicate various elements (components or ingredients) of a product. The elements may be determined based on sensor data from one or more sensor devices. The second set of features may indicate a level of quality of the product.

In the context of a weather system, the multivariate time series data may relate to weather and the first set of features may include features indicating temperature, pressure, and/or humidity, among other examples. The second set of features may indicate whether precipitation will occur at a particular time.

Prediction system 110 may include one or more devices configured to receive, generate, store, process, and/or provide information associated with time series forecasting using multivariate time series data with missing values, as explained herein. In some examples, prediction system 110 may be configured to perform regression tasks to determine a relationship between two sets of features of multivariate time series data, perform an imputation task to predict missing values from the multivariate time series data, and/or perform a forecasting task to predict new values for of multivariate time series data, as described herein.

As shown in FIG. 1, prediction system 110 may include a model training component 115, a model execution component 120, and a control system 125. Model training component 115 may include one or more devices configured to train a model to perform a regression task, an imputation task, and a forecasting task, as described in. In some examples, model training component 115 may train functions of the model using one or more loss functions. The one or more loss functions may be used to simultaneously train the model to perform the regression task, the imputation task, and the forecasting task. In other words, the model may be a multi-task model. In some examples, model training component 115 may obtain training data (e.g., from data server system 105) and provide the training data to train the model.

Control system component 125 may include one or more devices configured to execute the model to cause the model to perform the regression task, the imputation task, and the forecasting task. In some examples, control system component 125 may obtain input data (e.g., from data server system 105) and provide the input data as an input to the model. The model may perform the regression task, the imputation task, and the forecasting task using the input data.

Control system component 125 may include one or more devices configured to generate control information (e.g., instructions) to control an operation of controlled system 130. In some examples, control system component 125 may generate the control information based on an output of the model.

Controlled system 130 may include one or more devices configured to perform an operation based on an output of the model. In some examples, controlled system 130 may include one or more machines utilized in a manufacturing process of a product. For example, each device of controlled system 130 may generate an element (component or ingredient) of the product based on the control information. In some implementations, controlled system 130 may provide data to data server system 105. The data may be provided in a form of a stream data. In some examples, the data may be multivariate time series data regarding an operation of controlled system 130 (e.g., regarding an operation of the one or more devices of controlled system 130).

For instance, the multivariate time series data may include information regarding elements used to manufacture products for each period of time of a plurality of period. As an example, the multivariate time series data may indicate a first component, a second component, and a third component were used to manufacture a first product during a first hour of day one, a fourth component, a fifth component, and a sixth component were used to manufacture a second product during a second hour of day one, and so on. In some implementations, the multivariate data may identify a measure of quality of the products. For example, the multivariate data may identify a measure of quality of the first product but not include a measure of quality of the second product.

As shown in FIG. 1B, and by reference number 135, prediction system 110 may receive training data. For example, prediction system 110 may receive the training data from data server system 105. In some implementations, prediction system 110 may receive a training request to train a model. The training request may be received from a device of a user associated with prediction system 110. The user may be an administrator of prediction system 110. Based on receiving the training request, prediction system 110 may provide a data request to data server system 105. Prediction system 110 may receive the training data based on providing the data request. In some examples, the training data may be data generated by controlled system 130 during an operation of controlled system 130.

As shown in FIG. 1B, and by reference number 140, prediction system 110 may identify a first set of features and a second set of features of the training data. For example, prediction system 110 may analyze the training data to identifying the first set of features and the second set of features. In some implementations, the training data may include information identifying the first set of features and the second set of features. For instance, the training data may include data descriptors identifying the first set of features and the second set of features, metadata identifying the first set of features and the second set of features, among other examples.

Prediction system 110 may identify the first set of features and the second set of features based on the information identifying the first set of features and the second set of features. In some implementations, prediction system 110 may use model training component 115 to identify the first set of features and the second set of features. The first set of features may be a set of input features and the second set of features may be a set of target features.

As shown in FIG. 1C, and by reference number 145, prediction system 110 may train a first function to determine a relationship between the first set of features and the second set of features. For example, prediction system 110 may use model training component 115 to train the first function. Model training component 115 may be configured with an assumption that a mapping exists between the first set of features and the second set of features. Based on the assumption, model training component 115 may train the first function to determine the relationship between the first set of features and the second set of features. In this regarding, the first function may be a spatial relation function.

As shown in FIG. 1C, based on the assumption, model training component 115 may determine the following formula:

$$Y \approx f ( X ) \qquad ( 1 )$$

where Y is the second set of features, X is the first set of features, and f is the first function.

For example, based on the assumption, model training component 115 may identify an initial parameter for the first function. For instance, model training component 115 may determine that applying the initial parameter to the first set of features may yield the second set of feature. In some implementations, the initial parameter may be a randomly selected parameter. Additionally, or alternatively, the initial parameter may be selected based on historical data regarding parameters selected by model training component 115 to train functions similar to the first function.

The first function may be a deep learning model. For example, the first function may be a full connected neural network, such as a convolutional neural network (CNN), a long short-term memory (LSTM) network, and/or an attention-based method/transformer, among other examples. The first function may perform a regression task to determine the relationship between the first set of features and the second set of features.

In some implementations, model training component 115 may train the first function using a first loss function. For example, model training component 115 may train the first function using the following formula:

$${Loss}_{1} ( Z ) = {‖ ( Y - f ( X ) ) ⊙ {M}_{Y} ‖}_{F}^{2} \qquad ( 2 )$$

Where Loss1 is the first loss function, Z is the training data, Y is the second set, ⊙ is the Hadamard product, and M_{Y} is a mask matrix.

In some implementations, Y may be known and M_{Y} may provide masks to mask values of Y to indicate that the second set of features are missing. Model training component 115 may train the first function to determine the second set of features based on the masks indicating that the second set of features are missing.

Model training component 115 may use the first loss function over multiple iterations to train the first function to minimize a distance (or difference) between Y (the output expected from f) and f(X) (the actual output from f). For example, model training component 115 may train the first function to select different parameters (over the multiple iterations) to minimize the distance (or difference) between Y and f(X). During the multiple iterations, the first function (e.g., the neural network) may converge to a state of the first function that minimizes the distance (or difference) between Y and f(X). Based on the foregoing, for the training data Z=(X, Y), the first function may be trained to handle situations where only X can be (partially) observed and Y is completely missing.

As shown in FIG. 1C, and by reference number 150, prediction system 110 may train a second function to determine a relationship between missing data of a current period of time and complete data of a next period of time. For example, prediction system 110 may use model training component 115 to train the second function. Model training component 115 may be configured train the second function to perform an imputation task and a forecasting task using the same training data (e.g., same multivariate time series data). In other words, model training component 115 may train the second function to simultaneously perform the imputation task and the forecasting task. Accordingly, the second function may generate two outputs: an output resulting from performing the imputation task and an output resulting from performing the forecasting task.

In contrast, a common approach is to perform an imputation task to generate an output and perform a forecasting task using the output generated from the imputation task. By training the second function to perform the imputation task and the forecasting task using the same training data and to generate the two outputs, the second function may overcome the issues regarding the common approach as discussed above.

In some implementations, with respect to the second function, model training component 115 may determine the following formula:

$${Z}_{shift} = g ( Z ) \qquad ( 3 )$$

where Z_{shift} is an output resulting from performing the imputation task and an output resulting from performing the forecasting task, g is the second function, and Z is the training data. The relationship may be the above formula (3).

Alternatively, with respect to the second function, model training component 115 may determine the following formula:

$${Z}_{shift} = g ( [ X , f ( X ) ] ) \qquad ( 4 )$$

where Z_{shift} is an output resulting from performing the imputation task and an output resulting from performing the forecasting task, g is the second function, X is the first set of features, and f is the first function. The relationship may be the above formula (4).

In other words, in some implementations, the second function may receive as input the first set of features and an outcome of the first function. Accordingly, an output (or a signal) from a regression task of the first function (e.g., a downstream task) may be used to improve outputs of the second function. For example, the output from the regression task of the first function may be used to improve an output of the imputation task. In this regard, the output from the imputation task may be flexible and learnable.

As shown in FIG. 1C, as a result of performing the imputation task, the second function may be configured to determine (or predict) missing values (from the training data) for the current period of time. As further shown in FIG. 1C, as a result of performing the forecasting task, the second function may be configured to determine (or predict) future values (from the training data) for the next period of time that follows the current period of time. In some implementations, the second function may determine the missing values and the future values based on determining the relationship between the missing data of the current period of time and the complete data of the next period of time. In some circumstances, the second function may be trained to determine the relationship between the missing data and the complete data in a manner similar to the manner in which the first function is trained to determine the relationship between the first set of features and the second set of features.

In some implementations, the second function may be a deep learning model. For example, the second function may be a full connected neural network, such as a CNN, an LSTM network, and/or an attention-based method/transformer, among other examples.

In some implementations, model training component 115 may train the second function using a second loss function. For example, model training component 115 may train the second function using the following formula:

$${Loss}_{2} ( Z , {Z}_{shift} ) = {‖ ( {Z}_{shift} - g ( [ X , f ( X ) ] ) ) ⊙ {M}_{{Z}_{shift}} ‖}_{F}^{2} \qquad ( 5 )$$

Where Loss2 is the second loss function, Z is the training data, Z_{shift} is an output resulting from performing the imputation task and an output resulting from performing the forecasting task, g is the second function, X is the first set of features, and f is the first function, ⊙ is the Hadamard product, and M_{Zshift} is a mask matrix.

In some implementations, Z_{shift} may be known and M_{Zshift} may provide masks to mask values of Z_{shift} to indicate that the training data is missing values. Model training component 115 may train the second function to determine the outputs of the imputation and forecasting tasks based on the masks indicating that the training data is missing values.

Model training component 115 may use the second loss function over multiple iterations to train the second function to minimize a distance (or difference) between Z_{shift} (the outputs expected from g) and g([Z, f(X)]) (the actual output from g). For example, model training component 115 may train the second function to select different parameters (over the multiple iterations) to minimize the distance (or difference) between Z_{shift} and g([Z, f(X)]). During the multiple iterations, the second function (e.g., the neural network) may converge to a state of the second function that minimizes the distance (or difference) between Z_{shift} and g([Z, f(X)]).

In some examples, the second function may generate an intermediate output that is shared with the imputation task and the forecasting task. In this regard, the intermediate output may provide a link between the imputation task and the forecasting task.

In some implementations, a trained model (e.g., a multi-tasking model) may be obtained as a result of training the first function and the second function. The trained model may include the first function and the second function. In some examples, as a result of training the first function and the second function, the trained model may be configured to simultaneously perform the first function and the second function. Accordingly, the trained model may be configured to simultaneously perform the regression task, the imputation task, and the forecasting task.

In some implementations, model training component 115 may further train the trained model using the following formula:

$$Loss ( Z ) = {Loss}_{1} ( Z ) + {Loss}_{2} ( Z , {Z}_{shift} ) + reg ( w\_f , w\_g ) \qquad ( 5 )$$

Where Loss is a third loss function, Loss₁ is the first loss function, Loss₂ is the second loss function, Z is the training data, Z_{shift} is an output resulting from performing the imputation task and an output resulting from performing the forecasting task, w_f is a weight associated with the first function, w_g is a weight associated with the second function, and reg is some regularization function of the weights.

In some implementations, the trained model may be a deep learning model. For example, the trained model may comprise two deep learning models, which may include a full connected neural network, such as a CNN, an LSTM network, and/or an attention-based method/transformer, among other examples.

As shown in FIG. 1D, and by reference number 155, prediction system 110 may store the trained model obtained based on training the first function and the second function. For example, prediction system 110 may store the trained model in a memory associated with prediction system 110.

As shown in FIG. 1D, and by reference number 160, prediction system 110 may receive input data. For example, after the trained model has been trained and/or stored, prediction system 110 may receive the input data. For instance, prediction system 110 may receive the input data from data server system 105. In some situations, a user associated with data server system 105 may cause data server system 105 to provide the input data in order to determine missing values of the input data and/or to predict future values for the input data.

The input data may include a multivariate time series data. In some situations, the input data may be provided with missing values. For example, the input data may be provided with the first set of features being partially observed and/or with the second set of features missing.

As shown in FIG. 1D, and by reference number 165, prediction system 110 may process the input data using the trained model. For example, after receiving the input data, model execution component 120 may execute the trained model and provide the input data as an input to the trained model. The trained model may generate output data based on the input data. For example, the trained model may use the first function to determine a relationship between the first set of features of the input data and the second set of features of the input data. Simultaneously, the trained model may use the second function to perform an imputation task on the input data and perform a forecasting task on the input data.

For example, the second function may perform the imputation task to determine missing values of the input data for a current period of time. Additionally, or alternatively, the second function may perform the forecasting task to predict future values of the input data for a subsequent period of time. Accordingly, the trained model may produce two outputs: the missing values and the predicted future values. In some implementations, the missing values may be provided to data server system 105.

As shown in FIG. 1D, and by reference number 170, prediction system 110 may generate control information based on the output data of the trained model. For example, controlled system 130 may use the output data to generate the control information to control an operation of controlled system 130. The output data may include the missing values and the predicted future values.

In the context of a manufacturing process, based on the output data, controlled system 130 may generate the control information to adjust a quantities of elements used to manufacture a product, remove one or more of the elements, replace on or more of the elements, among other examples.

As shown in FIG. 1D, and by reference number 175, prediction system 110 may provide the control information to control an operation of controlled system 130. For example, controlled system 130 may provide the control information to cause controlled system 130 to adjust a quantities of elements used to manufacture a product, remove one or more of the elements, replace on or more of the elements, among other examples.

As explained, implementations described herein provide a framework that includes two functions. The first function may be configured to determine the relationship between the first set of features and the second set of features. The second function may be configured to simultaneously perform imputation tasks and forecasting tasks on a same multivariate time series data. The first function may a spatial relation function while the second function may be a temporal relation function.

The functions may be trained using a training loss function configured to simultaneously learn a regression task (to determine the relationship between the sets of features), an imputation task (for a current period of time), and a forecasting task (for a future period of time). For at least the foregoing reasons, implementations described herein handle the processing of full data (e.g., multivariate time series data with no missing values) and missing data (e.g., multivariate time series data with missing values) with flexibility.

Additionally, implementations described herein handle various time series tasks (e.g., imputation tasks and forecasting tasks) simultaneously. Accordingly, implementations described herein may preserve computing resources, network resources, and other resources that would have otherwise been used by the common approach to addressing missing values in multivariate time series data, used to remedy inaccuracies with respect to forecasted multivariate time series data under the common approach, among other examples.

As indicated above, FIGS. 1A-1D are provided as an example. Other examples may differ from what is described with regard to FIGS. 1A-1D. The number and arrangement of devices shown in FIGS. 1A-1D are provided as an example. A network, formed by the devices shown in FIGS. 1A-1D may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

FIG. 2 is a diagram of an example environment 200 in which systems and/or methods described herein can be implemented. As shown in FIG. 2, environment 200 may include data server system 105, prediction system 110, and controlled system 130. Data server system 105, prediction system 110, and controlled system 130 have been described above in connection with FIG. 1. Devices of environment 200 can interconnect via wired connections, wireless connections, or a combination of wired and wireless connections.

Data server system 105 may include a communication device and a computing device. For example, data server system 105 includes computing hardware used in a cloud computing environment. In some examples, data server system 105 may include a server, such as an application server, a client server, a web server, a database server, a host server, a proxy server, a virtual server (e.g., executing on computing hardware), or a server in a cloud computing system.

Prediction system 110 may include a communication device and a computing device. For example, prediction system 110 includes computing hardware used in a cloud computing environment. In some examples, prediction system 110 may include a server, such as an application server, a client server, a web server, a database server, a host server, a proxy server, a virtual server (e.g., executing on computing hardware), or a server in a cloud computing system. In some implementations, prediction system 110 may include model training component 115, model execution component 120, and control system 125.

Controlled system 130 may include a communication device and a computing device. For example, controlled system 130 includes computing hardware used in a cloud computing environment. In some examples, controlled system 130 may include a server, such as an application server, a client server, a web server, a database server, a host server, a proxy server, a virtual server (e.g., executing on computing hardware), or a server in a cloud computing system.

Network 210 includes one or more wired and/or wireless networks. For example, network 210 may include Ethernet switches. Additionally, or alternatively, network 210 may include a cellular network, a public land mobile network (PLMN), a local area network (LAN), a wide area network (WAN), a private network, the Internet, and/or a combination of these or other types of networks. Network 210 enables communication between data server system 105, prediction system 110, and controlled system 130.

The number and arrangement of devices and networks shown in FIG. 2 are provided as an example. In practice, there can be additional devices and/or networks, fewer devices and/or networks, different devices and/or networks, or differently arranged devices and/or networks than those shown in FIG. 2. Furthermore, two or more devices shown in FIG. 2 can be implemented within a single device, or a single device shown in FIG. 2 can be implemented as multiple, distributed devices. Additionally, or alternatively, a set of devices (e.g., one or more devices) of environment 200 can perform one or more functions described as being performed by another set of devices of environment 200.

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as new time series forecasting code 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 1. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

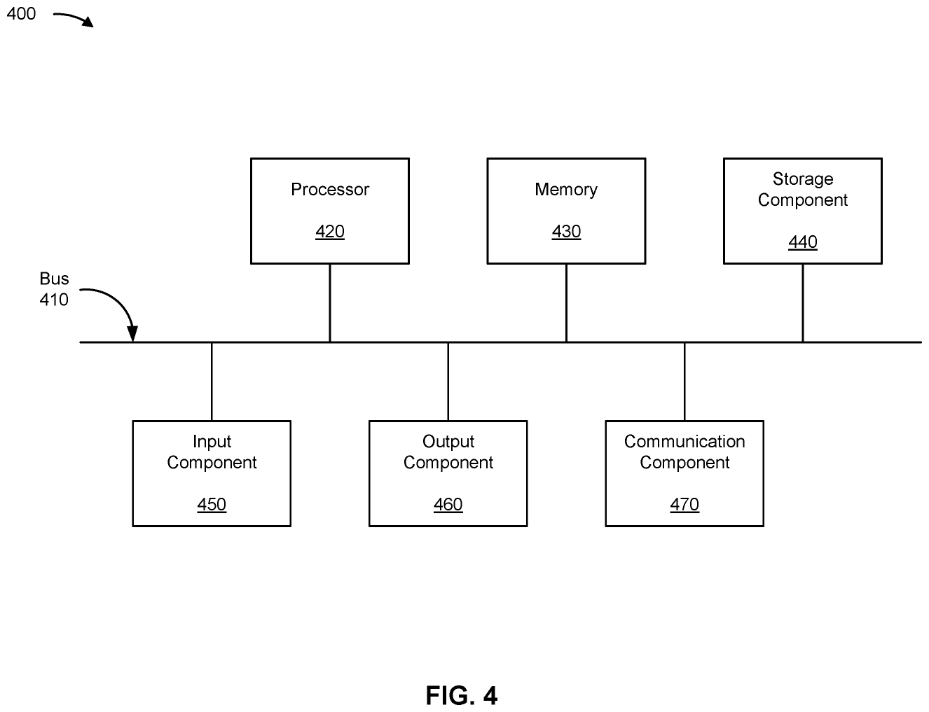

FIG. 4 is a diagram of example components of a device 400, which may correspond to data server system 105, prediction system 110, and/or controlled system 130. In some implementations, data server system 105, prediction system 110, and/or controlled system 130 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

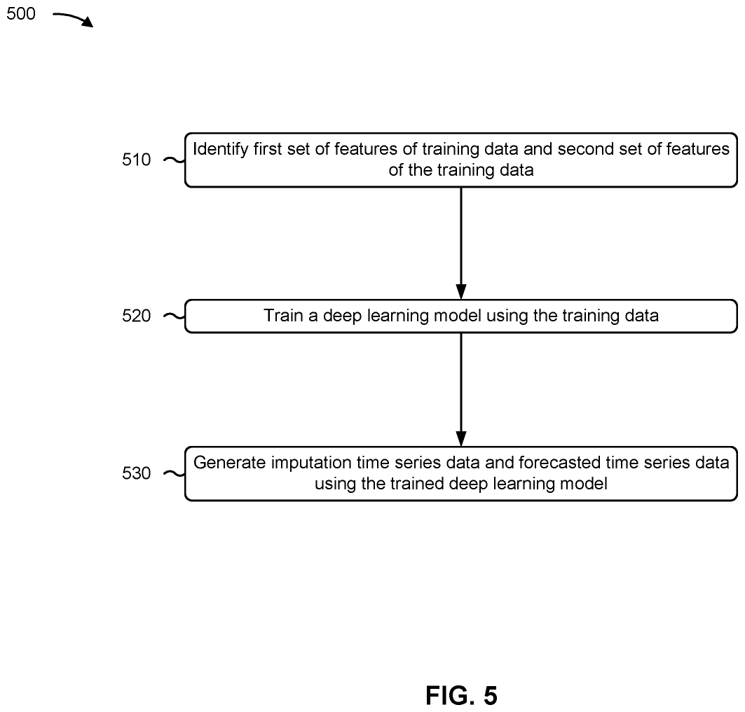

FIG. 5 is a flowchart of an example process 500 relating to time series forecasting. In some implementations, one or more process blocks of FIG. 5 may be performed by a prediction system (e.g., prediction system 110). In some implementations, one or more process blocks of FIG. 5 may be performed by another device or a group of devices separate from or including the prediction system, such as a data server system (e.g., data server system). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include identifying first set of features of training data and second set of features of the training data (block 510). For example, the prediction system may identify first set of features of training data and second set of features of the training data, as described above. In some implementations, the first set of features may include quantitative features and the second set of features may include qualitative features.

As further shown in FIG. 5, process 500 may include training a deep learning model using the training data (block 520). For example, the prediction system may train a deep learning model using the training data, as described above. In some implementations, training the deep learning model comprises training a first function to determine a relationship between the first set of features and the second set of features, and training a second function to determine a relationship between missing data of a current time and complete data of a current time step and future time steps.

As further shown in FIG. 5, process 500 may include processing input data using the trained deep learning model (block 530). For example, the prediction system may process input data using the trained deep learning model to cause the trained deep learning model to perform: an imputation task on the input data to obtain imputation time series data, and a forecasting task on the input data to obtain forecasted time series data, as described above.

In some implementations, process 500 includes obtaining the input data from a data server system, generating control information to control an operation of a system associated with the data server system and controlling the operation of the system using the control information. The control information is generated using the imputation time series data and the forecasted time series data.

In some implementations, providing the input data to cause the trained deep learning model to perform the imputation task and the forecasting task comprises providing the input data to cause the trained deep learning model to simultaneously perform the imputation task and the forecasting task.

In some implementations, the input data is provided with missing values. Performing the imputation task on the input data to obtain the imputation time series data comprises performing the imputation task on the input data to obtain the missing values for a first period of time. Performing the forecasting task on the input data to obtain the forecasted time series data comprises performing the forecasting task on the input data to forecast time series data for a second period of time that follows the first period of time.

In some implementations, training the first function comprises using a loss function to minimize a difference between an actual output of the first function and an expected output of the first function. The expected output includes the second set of features.

In some implementations, training the second function comprises using a loss function to minimize a difference between an actual output of the second function and an expected output of the second function. The expected output includes outputs of the imputation tasks and the forecasting tasks.

In some implementations, the deep learning model is a first deep learning model, the first function is a second deep learning model trained to determine missing values from multivariate time series data provided to the second deep learning model, and the second function is a third deep learning model trained to forecast multivariate time series data from the multivariate time series data provided to the second deep learning model.

In some implementations, training the second function may include providing masks, in the training data, to indicate time series data that is missing; and training the second function to determine the time series data based on the masks indicating that the time series data that is missing; and using a loss function to minimize a difference between an actual output of the second function and an expected output of the second function. The actual output may include the determined time series data and the expected output may include the time series data that is missing.

In some implementations, training the first function may include providing a parameter indicating an initial relationship between the first features and the second features; training the first function to determine the second features based on the parameter; and using a loss function to minimize a difference between an actual output of the first function and an expected output of the first function. The actual output may include the determined second features and the expected output may include the second features.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
identifying a first set of features of training data and a second set of features of the training data;
training a deep learning model using the training data,
wherein training the deep learning model comprises training a first function to determine a relationship between the first set of features and the second set of features, and training a second function to determine a relationship between missing data of a first period of time and complete data of a second period of time that follows the first period of time; and
generating imputation time series data and forecasted time series data using the trained deep learning model,
wherein the imputation time series data is generated based on the trained deep learning model performing an imputation task on input data, and
wherein the forecasted time series data is generated based on the trained deep learning model performing a forecasting task on the input data.

2. The computer-implemented method of claim 1, further comprising:
obtaining the input data from a data server system;
generating control information to control an operation of a system associated with the data server system,
wherein the control information is generated using the imputation time series data and the forecasted time series data; and
controlling the operation of the system using the control information.

3. The computer-implemented method of claim 1, wherein the input data is provided with missing values,
wherein performing the imputation task on the input data to obtain the imputation time series data comprises:
performing the imputation task on the input data to obtain the missing values for a first period of time, and
wherein performing the forecasting task on the input data to obtain the forecasted time series data comprises:
performing the forecasting task on the input data to forecast time series data for a second period of time that follows the first period of time.

4. The computer-implemented method of claim 3, further comprising:
providing the input data to cause the trained deep learning model to simultaneously perform the imputation task and the forecasting task.

5. The computer-implemented method of claim 1, wherein training the first function comprises:
using a loss function to minimize a difference between an actual output of the first function and an expected output of the first function,
wherein the expected output includes the second set of features.

6. The computer-implemented method of claim 1, wherein training the second function comprises:
using a loss function to minimize a difference between an actual output of the second function and an expected output of the second function,
wherein the expected output includes outputs of the imputation tasks and the forecasting tasks.

7. The computer-implemented method of claim 1, wherein the deep learning model is a first deep learning model,
wherein the first function is a second deep learning model trained to determine missing values from multivariate time series data provided to the second deep learning model, and
wherein the second function is a third deep learning model trained to forecast multivariate time series data from the multivariate time series data provided to the second deep learning model.

8. A computer program product comprising:
one or more computer readable storage media, and program instructions collectively stored on the one or more computer readable storage media, the program instructions comprising:
program instructions to train a machine learning model using training data,
wherein the training data includes a first set of features and a second set of features, and
wherein the program instructions to train the machine learning model comprise:
program instructions to train a first function to determine a relationship between the first set of features and the second set of features, and
program instructions to train a second function to determine a relationship between missing data of a first period of time and complete data of a second period of time that follows the first period of time;
program instructions to generate imputation time series data and forecasted time series data using the trained machine learning model,
wherein the imputation time series data is generated based on the trained deep learning model performing an imputation task on input data, and
wherein the forecasted time series data is generated based on the trained deep learning model performing a forecasting task on the input data; and
program instructions to control an operation of one or more devices using the imputation time series data and the forecasted time series data.

9. The computer program product of claim 8, wherein the machine learning model is a first deep learning model,
wherein the first function is a second deep learning model trained to determine missing values from multivariate time series data provided to the second deep learning model, and
wherein the second function is a third deep learning model trained to forecast multivariate time series data from the multivariate time series data provided to the second deep learning model.

10. The computer program product of claim 9, wherein the program instructions to train the first function comprise:
program instructions to use a loss function to minimize a difference between an actual output of the first function and an expected output of the first function,
wherein the actual output includes the second set of features determined using the machine learning model, and
wherein the expected output includes the second set of features.

11. The computer program product of claim 8, wherein the program instructions to train the second function comprise:
program instructions to provide masks, in the training data, to indicate time series data that is missing; and
program instructions to train the second function to determine the time series data based on the masks indicating that the time series data that is missing.

12. The computer program product of claim 11, wherein the program instructions to train the second function comprise:
program instructions to use a loss function to minimize a difference between an actual output of the second function and an expected output of the second function,
wherein the actual output includes the determined time series data, and
wherein the expected output includes the time series data that is missing.

13. The computer program product of claim 8, wherein the first set of features include quantitative features of multivariate time series data, and
wherein the second set of features include qualitative features.

14. The computer program product of claim 8, wherein the first function is a first deep learning model,
wherein the second function is a second deep learning model, and
wherein the program instructions to train the second function comprises:
program instructions to train the second deep learning model to simultaneously perform the imputation tasks and the forecasting tasks.

15. A system comprising:
one or more devices configured to:
train a machine learning model using training data,
wherein the training data includes first features and second features, and
wherein, to train the machine learning model, the one or more devices are configured to:
train a first function to determine a relationship between the first features and the second features, and
train a second function to determine a relationship between missing data of a first period of time and complete data of a second period of time that follows the first period of time;
generate imputation time series data and forecasted time series data using the trained machine learning model,
wherein the imputation time series data is generated based on the trained machine learning model performing an imputation task on input data, and
wherein the forecasted time series data is generated based on the trained machine learning model performing a forecasting task on the input data; and
provide the imputation time series data and the forecasted time series data to control an operation of a system.

16. The system of claim 15, wherein the input data is provided with missing values, and
wherein, to perform the imputation task on the input data to obtain the imputation time series data, the one or more devices are configured to:
perform the imputation task on the input data to obtain the missing values.

17. The system of claim 16, wherein the one or more devices are further configured to:
obtain the input data from a data server system associated with the system; and
provide the missing values to the data server system.

18. The system of claim 15, wherein the first function is a first deep learning model trained to determine missing values from input provided to the first deep learning model, and
wherein the second function is a second deep learning model trained to forecast time series data from the input provided to the first deep learning model.

19. The system of claim 15, wherein, to train the first function, the one or more devices are configured to:
provide a parameter indicating an initial relationship between the first features and the second features;
train the first function to determine the second features based on the parameter; and
use a loss function to minimize a difference between an actual output of the first function and an expected output of the first function,
wherein the actual output includes the determined second features, and
wherein the expected output includes the second features.

20. The system of claim 15, wherein, to train the first function, the one or more devices are configured to:
use a loss function to minimize a difference between an actual output of the second function and an expected output of the second function.
